(19) United States
(12) Patent Application Publication
(10) Pub. No.: US 2020/0380391 A1
(43) Pub. Date: Dec. 3, 2020

(54) METHODS AND SYSTEMS FOR PREDICTING ELECTROMECHANICAL DEVICE FAILURE

(71) Applicant: CACI, Inc. - Federal, Arlington, VA (US)

(72) Inventors: Matt Allard, Colorado Springs, CO (US); Matt Egger, Colorado Springs, CO (US); Steve Black, Colorado Springs, CO (US); Tom Perry, Colorado Springs, CO (US); Greg Grewe, Colorado Springs, CO (US); Long Vo, Colorado Springs, CO (US)

(21) Appl. No.: 16/798,889

(22) Filed: Feb. 24, 2020

Related U.S. Application Data
(60) Provisional application No. 62/854,254, filed on May 29, 2019.

(51) Int. Cl. G06N 5/04; G06N 20/00

(52) U.S. Cl. CPC G06N 5/04; G06N 20/00

(57) ABSTRACT

Methods and systems for predicting electromechanical device failure are disclosed. In an example method, an analytic model, configured to implement predictive diagnostics for an electromechanical device, may be provided. Sensor data may be received from the electromechanical device, which may comprise a plurality of time series for a sensor-measurable parameter associated with operation of the electromechanical device. One or more machine learning processes may be used to update the analytic model. The one or more machine learning processes may comprise determining one or more data anomalies in the plurality of time series. The updated analytic method may be deployed to implement updated predictive diagnostics for the electromechanical device.

### FIELD

This application generally relates to electromechanical devices and more particularly to predicting failure of electromechanical devices.

### BACKGROUND

Over time, an electromechanical device, such as a ground aerospace antenna, will be subject to various stressors that may cause the device or one of its components to eventually fail. In additional to the usual and ordinary operation of the device, other factors, such as the temperature, humidity level, or amount of precipitation at the installation site, may affect when or if the device fails. Due to these combined variables, devices installed at one location may tend to fail at a different rate than similar devices installed at a second location. And failure of an electromechanical device during field operations may have serious consequences. For example, failure of the example ground aerospace antenna may cause an associated mission or operation to be significantly hindered or even fail, including catastrophic secondary system failures.

Thus, what is desired in the art is a technique and architecture for predicting electromechanical device failure well in advance of system damage and unplanned outage.

### SUMMARY

The foregoing needs are met, to a great extent, by the disclosed systems, methods, and techniques for predicting electromechanical device failure.

One aspect of the patent application is directed to updating an existing analytic model configured to implement predictive diagnostics for an electromechanical device. In an example method, an analytic model, configured to implement predictive diagnostics for an electromechanical device, may be provided. The analytic model may be configured to determine a predictive output based on first sensor data from the electromechanical device. Second sensor data may be received from the electromechanical device, which may comprise a plurality of time series for a sensor-measurable parameter associated with operation of the electromechanical device. One or more machine learning processes may be used to update the analytic model. The one or more machine learning processes may comprise determining one or more data anomalies in the plurality of time series. The updated analytic method may be deployed to implement updated predictive diagnostics for the electromechanical device. The updated analytic model may be configured to determine a predictive output based on third sensor data from the electromechanical device.

One aspect of the patent application is directed to training an analytic model configured to implement predictive diagnostics for an electromechanical device. In an example method, sensor data associated with an electromechanical device may be received. The sensor data may comprise a plurality of time series for a sensor-measurable parameter associated with operation of the electromechanical device. The sensor data may have been determined via at least one of a computer simulation of the electromechanical device, a scale model of the electromechanical device, or a field-deployed electromechanical device of the same type as the electromechanical device. One or more machine learning processes may be used to train an analytic model associated with the electromechanical device. The one or more machine learning processes may comprise determining one or more data anomalies in the plurality of time series for the sensor-measurable parameter. The analytic model may be deployed to implement predictive diagnostics for the electromechanical device. The analytic model may be configured to determine a predictive output based on sensor data from the electromechanical device.

There has thus been outlined, rather broadly, certain embodiments of the application in order that the detailed description thereof herein may be better understood, and in order that the present contribution to the art may be better appreciated. There are, of course, additional embodiments of the application that will be described below and which will form the subject matter of the claims appended hereto.

### BRIEF DESCRIPTION OF THE DRAWINGS

To facilitate a fuller understanding of the application, reference is made to the accompanying drawings, in which like elements are referenced with like numerals. These drawings should not be construed to limit the application and are intended only for illustrative purposes.

FIG. 1 illustrates a diagram of an example system according to an aspect of the application.

FIG. 2A illustrates a partial cut-away view of an example antenna according to an aspect of the application.

FIG. 2B illustrates a partial cut-away view of an example pedestal assembly according to an aspect of the application.

FIG. 3 illustrates a block diagram of an example computing system according to an aspect of the application.

FIG. 4 illustrates a data and process flowchart according to an aspect of the application.

FIG. 5 illustrates a data and process flow flowchart according to an aspect of the application.

FIG. 6 illustrates a diagram of an example system according to an aspect of the application.

FIG. 7A illustrates a scale model according to an aspect of the application.

FIG. 7B illustrates a gear usable with the scale model of FIG. 7A according to an aspect of the application.

FIG. 8 illustrates a method flowchart according to an aspect of the application.

FIG. 9 illustrates a method flowchart according to an aspect of the application.

FIGS. 10-13A illustrate time series line graphs according to an aspect of the application.

FIG. 13B illustrates time series block graphs according to an aspect of the application.

FIGS. 14A-C and 15A-B illustrate partial views of an aerospace antenna pedestal assembly and attached sensors according to an aspect of the application.

### DETAILED DESCRIPTION

Before explaining at least one embodiment of the application in detail, it is to be understood that the application is not limited in its application to the details of construction and to the arrangements of the components set forth in the following description or illustrated in the drawings. The application is capable of embodiments in addition to those described and of being practiced and carried out in various ways. Also, it is to be understood that the phraseology and terminology employed herein, as well as the abstract, are for the purpose of description and should not be regarded as limiting.

Reference in this application to “one embodiment,” “an embodiment,” “one or more embodiments,” or the like means that a particular feature, structure, or characteristic described in connection with the embodiment is included in at least one embodiment of the disclosure. The appearances of, for example, the phrases “an embodiment” in various places in the specification are not necessarily all referring to the same embodiment, nor are separate or alternative embodiments mutually exclusive of other embodiments. Moreover, various features are described which may be exhibited by some embodiments and not by the other. Similarly, various requirements are described which may be requirements for some embodiments but not for other embodiments.

The apparatus, systems, and methods for predicting failure of an electromechanical device utilize artificial intelligence systems combined with particular sensors to monitor conditions of the electromechanical device to predict failure events. The predictive nature of the apparatus, systems, and methods described herein can provide better planning tools for maintaining or replacing electromechanical devices. Predicting time to failure can complement or otherwise optimize reliability centered maintenance (RCM) programs for the electromechanical device.

An artificial intelligence system may apply machine learning to identify predictive anomalies in sensor data captured by one or more sensors positioned on or near an electromechanical device. For example, sensor data can indicate an intermittent electrical failure, wear of a bearing or other contact surface, motor irregularities, gear defects (i.e., a missing tooth, fatigue, or severe wear) or other anomaly that may lead eventually to catastrophic failure. The artificial intelligence system can use any one of a number of machine learning algorithms to include but not limited to condition monitoring and prediction algorithm development, including deep learning. The condition and predictive approach allows monitoring of electromechanical devices without setting performance criteria, which could vary by implementation, location, weather conditions, or other circumstances. The individualized nature of the condition and predictive monitoring system can allow the system to be adaptive to a variety of conditions and implementations.

A warning system can provide the user specific information about the predicted failure. For example, the warning system can indicate a predicted time to failure, a specific indication of failure (electrical, mechanical, or otherwise), or other warning indication.

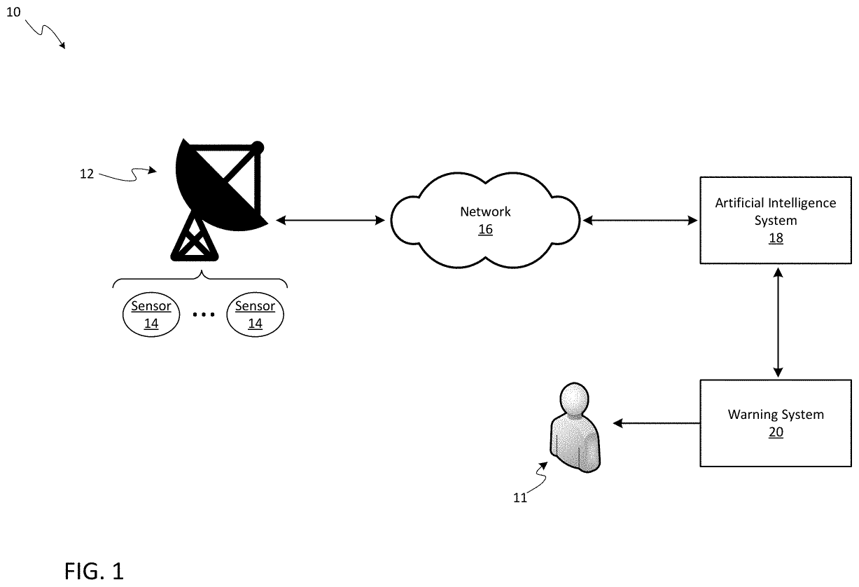

FIG. 1 is a diagram of an example system 10 in which one or more disclosed embodiments may be implemented. The system 10 comprises an electromechanical device 12 (or simply device 12 hereinafter) and one or more sensors 14 configured to record various measurements relating to the operation of the device 12. The sensors 14 may also be configured to measure various environmental conditions at the device 12. The sensor data may be sent, via a network 16, to an artificial intelligence (AI) system 18. The AI system 18 may process the sensor data to determine, at least in part, a predictive model (e.g., an analytic model) for implementing predictive diagnostics with respect to the device 12 and/or similar devices. The predictive model may be determined via machine learning processes. The AI system 18 may further determine, based on data from the sensors 14, condition monitoring and predictive algorithms relating to the device 12 or similar devices. Synthetic data, such as from a simulation or computer model of the device 12, may be also used to determine the predictive model, the condition monitoring algorithm, and the predictive algorithm.

Additionally or alternatively, the AI system 18 may receive sensor data from the device 12 after a predictive model has already been determined for the device 12. Rather than (or in addition to) using the sensor data to determine a predictive model, the AI system 18 may use an existing predictive model to perform predictive diagnostics for the device 12. For example, the AI system 18 may determine that a motor gearbox of the device 12 is likely to fail. The AI system 18 may communicate with a warning system 20 via which a user 11 (e.g., maintenance personnel) is notified of the predicted gearbox failure. In some aspects, subsequent instances of sensor data may be used to refine an existing predictive model.

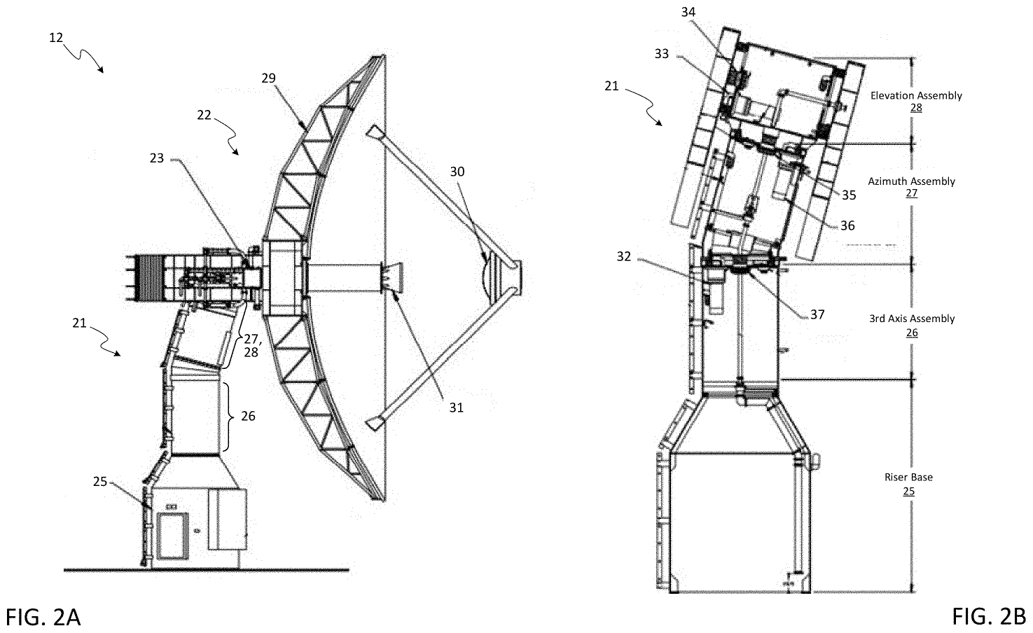

As used herein, a “device” may refer to a system or device as a whole, such as the whole of the antenna configuration shown in FIGS. 2A-B, or may refer to a component of a larger device or system, such as one of the motor gearbox assemblies shown in FIGS. 2A-B. “Failure” of the device 12, as used herein, may comprise a state such that the device 12 is unable to perform its intended function. Failure may also include a state in which the device 12 is able to function but only with substantially degraded performance. In some aspects, failure of a sub-component of the device 12 may be considered a failure of the device 12 itself, whether or not the device 12 as a whole is able to perform its initial functions or not. For example, a device 12 may have redundant sub-components such that failure of one sub-component would not impact the device's 12 overall performance. Yet the failure of one of the redundant sub-components may still be considered a failure of the device 12.

The device 12 is depicted in FIG. 1 as an aerospace antenna (which may also be referred to as a ground terminal, ground station, or similar). Although the instant application shall often describe predictive diagnostic techniques in the context of an aerospace antenna, the disclosure is not so limited and may apply equally to electromechanical devices in general. An electromechanical device may be or comprise one or more moving components. As some examples, a moving component may include an electric motor or other type of motor, a gearbox, a pump (e.g., pneumatic, hydraulic, electric, or piezoelectric), a bearing or rotating surfaces, a belt or chain drive assembly, a gas compressor, a cam mechanism, or a piston and cylinder assembly. In some aspects, the device 12 may perform functions with a relatively high cycle count, such as may be the case with a rotating, reciprocating, or oscillating device. The resultant high cycle count data may be useful in establishing a body of normative data from which a predictive model may be determined, although the disclosure is not so limited.

Additional example electromechanical devices or systems to which the disclosed techniques may be applied include automobiles, trucks, trains, buses, tractors, farming equipment, autonomous vehicles and other land vehicles; helicopters, airplanes, spacecraft and other flying devices; wind turbines, hydroelectric turbines, electrical generators, and other power devices; and pumps, pipelines, chemical manufacturing facilities, refrigeration units, heating and cooling systems, construction equipment, bioreactors, fermentation systems, and other industrial equipment.

The system 10 may include additional devices 12 that share predictive diagnostics with the initial device 12. For example, the system 10 may include multiple devices 12 with the same or similar specifications and/or operating in the same or similar location or environment. For example, shared predictive diagnostics may be developed and implemented for multiple antennas of the same or similar model. Additionally or alternatively, the multiple antennas may each operate under the same or similar environmental conditions. Additionally or alternatively, the multiple antennas may have the same or similar installation configuration or type (e.g., a roof-top metal structure versus a ground-based concrete foundation). The multiple antennas may be co-located at a site or located at different sites. Co-located antennas may tend to have common environmental conditions and/or installation configurations or types, although not necessarily.

The one or more sensors 14 may record data that is related to the operation of the device 12. For example, the sensors 14 may measure vibrations, such as those caused by a rotating part or other cyclic movement. Measured vibrations may comprise vertical and/or horizontal vibrations. The sensors 14 may measure accelerations, including vertical and horizontal accelerations. The sensors 14 may measure an electric current, such as the current going to power an electric motor, including the amperage, voltage, or wattage of the current. The sensors 14 may record (e.g., determine) acoustic data, such as sounds or acoustic emissions generated by the device 12. The acoustic data may be associated in particular with a component or aspect of the device 12 that is vulnerable to failure and/or is a subject of the predictive diagnostics. The sensors 14 may record the temperature of the device 12, such as at a portion of the device 12 with a moving component that may generate excess heat when starting to fail. The above data may be represented as respective data time series.

Additionally or alternatively, the one or more sensors 14 may record data relating to the environmental conditions in which the device 12 operates. For example, the sensors 14 may measure the ambient temperature, humidity, wind speed, wind direction, and/or precipitation at the device's 12 location.

Accordingly, the sensors 14 may include one or more of: an accelerometer, vibroscope, or other vibration sensor; a microphone or other acoustic sensor; an ammeter, galvanometer, or other amperage sensor; a voltmeter, potentiometer, or other voltage sensor; a thermometer, thermocouple, or other temperature sensor; a hygrometer, humidistat, or other humidity sensor; a rain gauge, snow gauge, or other precipitation sensor; or an anemometer or other wind gauge. The sensors 14 may be positioned on the device 12, in the device 12, or proximate the device 12. For example, a sensor 14 configured to measure the humidity at an antenna site need not by installed on the antenna itself but merely in the same general vicinity.

As noted, the AI system 18 may receive sensor data from the sensors 14 associated with the device 12. The AI system 18 may develop a machine learning predictive model configured to perform predictive diagnostics. The predictive model may be particular to a certain device 12 or a certain set of devices 12 (e.g., multiple devices 12 of the same make and model and at the same site). In furtherance of this objective, the AI system 18 may determine a condition monitoring algorithm and a prediction algorithm. Such aspects will be described further herein.

The AI system 18 may be communicatively connected to the warning system 20. The warning system 20 may receive predictive diagnostic information (e.g., a predicted time for failure) from the AI system 18. Based on the predictive diagnostic information, the warning system 20 may initiate an appropriate communication to the user 11, such as via a computing device of the user 11. For example, the warning system 20 may send an email, text message, or other form of data to the user's 11 computing device to indicate the predicted failure of the device 12. The data to the user 11 may also indicate the nature of the failure, such as whether it is electrical or mechanical in nature. Additionally or alternatively, the warning system 20 may determine a maintenance schedule for the device 12 so that the device 12 is serviced or replaced before failure.

The AI system 18 and the warning system 20 may each comprise one or more computing devices (e.g., servers). The AI system 18 and the warning system 20 may each comprise a network and/or one or more network devices (e.g., network switches, bridges, routers, etc.) to interconnect the constituent computing devices. The AI system 18 and the warning system 20 may be integrated into a single system or may remain as separate systems. One or both of the AI system 18 and the warning system 20 may be located remote from the device 12. Or one or both of the AI system 18 and the warning system 20 may be located at the same site as the device 12.

The network 16 may be a fixed network (e.g., Ethernet, Fiber, ISDN, PLC, or the like) or a wireless network (e.g., WLAN, cellular, or the like) or a network of heterogeneous networks. For example, the network 16 may be comprised of multiple access networks that provide communications, such as voice, data, video, messaging, broadcast, or the like. Further, the network 16 may comprise other networks such as a core network, the Internet, a sensor network, an industrial control network, a personal area network, a fused personal network, a satellite network, a home network, or an enterprise network, as some examples.

FIG. 2A is a partial cutaway drawing of the device 12 embodied as an aerospace antenna. FIG. 2B is a partial cutaway drawing of a pedestal assembly 21 of the device 12. The device 12 may be configured to send and receive radio transmissions to and from a communications satellite. The device 12 comprises a reflector assembly 22 supported by the aforementioned pedestal assembly 21. The pedestal assembly 21 may generally control the position and directionality of the reflector assembly 22. The reflector assembly 22 comprises a reflector 29, a sub-reflector 30, an RF assembly 23, and a feed 31 to realize said radio transmissions. As examples, the reflector assembly 22 may be in a 2.4 meter configuration or a 6 meter configuration.

The pedestal assembly 21 comprises, from top to bottom, a riser base 25, a 3rd axis assembly 26, an azimuth assembly 27, and an elevation assembly 28. The elevation assembly 28 is only partially visible in FIG. 2A. The azimuth assembly 27, via its azimuth resolver 35 and azimuth motor gearbox 36, may enable movement (e.g., rotation) of the reflector assembly 22 with respect to the azimuth axis of the device 12. The elevation assembly 28, via its elevation resolver 34 and elevation motor gearbox 33, may enable movement of the reflector assembly 22 with respect to the elevation axis of the reflector assembly 22. The 3rd axis assembly 26, via its 3rd axis resolver 37 and 3rd axis motor gearbox 32, may enable movement of the reflector assembly 22 with respect to a cross-level axis of the reflector assembly 22. A motor gearbox assembly may comprise an electric (or other type) motor to drive the gearbox or a drive source may be external to a gearbox assembly. As examples, the azimuth motor gearbox 36, the elevation motor gearbox 33, and the 3rd axis motor gearbox 32 may be components of the device 12 that are vulnerable to failure and predictive diagnostics may be applied to such components. For example, the teeth of one or more gears in a motor gearbox may break or become worn over time. As another example, the device 12 may comprise one or more bearings (e.g., thrust bearings) to affect rotation about one of the aforementioned axes. These also may be vulnerable to failure and thus amenable to predictive diagnostics.

Although not shown in FIGS. 2A-B, the pedestal assembly 21 may be configured with one or more vibration sensors, one or more acoustic sensors, one or more current sensors, and one or more temperature sensors. A sensor may be strategically placed on or in the device 12 to provide the most useful data for a particular monitored component. For example, a vibration sensor may be placed on or near the elevation assembly 28 to record the vibrations caused by the elevation motor gearbox 33.

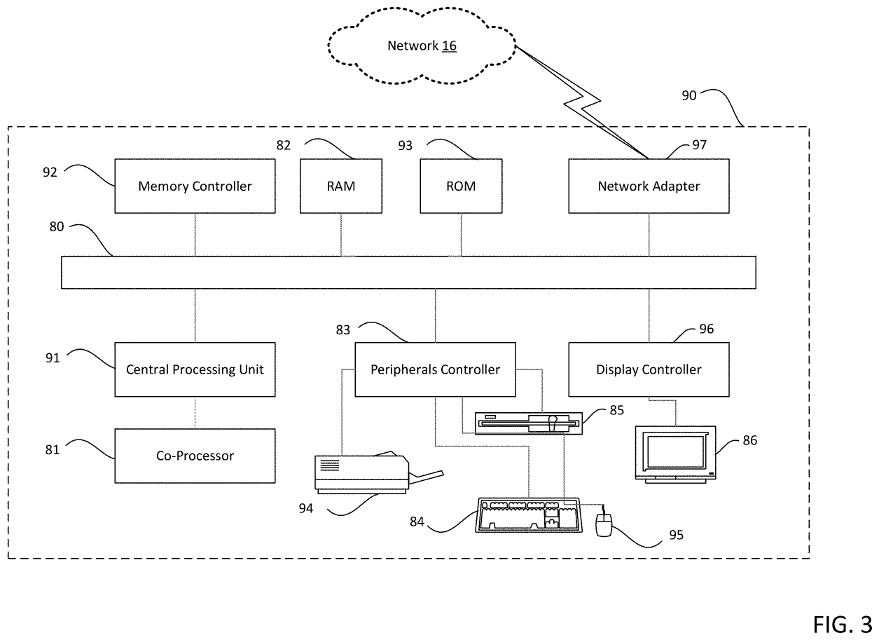

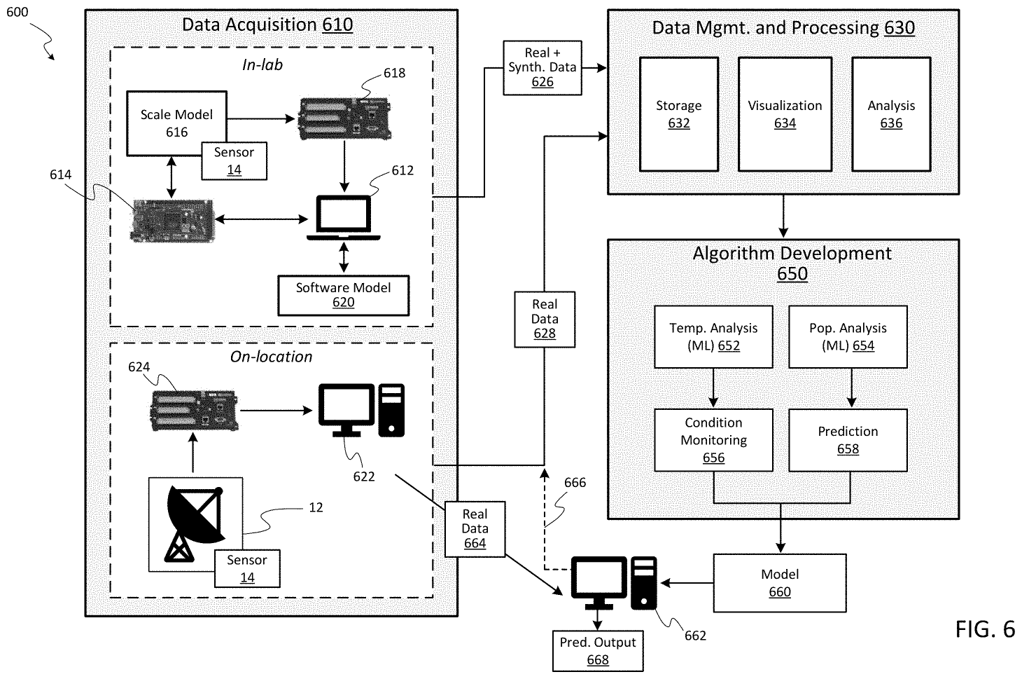

FIG. 3 is a block diagram of an exemplary computing system 90 which may be used to implement components of the system, including the AI system 18 and the warning system 20 of FIG. 1 and the lab computing device 612, on-location computing device 622, and the edge computing device 662 of FIG. 6. The device 12 of FIGS. 1, 2A, and 6 may also integrate a computing system 90, such as a controller. The computing system 90 may comprise a computer, a server, a laptop, a personal computer, a mobile device, a smart phone, a table computer, or other form of computing device. The computing system 90 may also comprise a field-programmable gate array (FPGA), an application-specific integrated circuit (ASIC), or a programmable logic controller (PLC). The computing system 90 may be controlled primarily by computer readable instructions, which may be in the form of software accessed by the computing system 90, including software stored on the computing system 90 or software stored remotely. Such computer readable instructions may be executed within a processor, such as a central processing unit (CPU) 91, to cause the computing system 90 to do work. In many known workstations, servers, and personal computers, the central processing unit 91 is implemented by a single-chip CPU called a microprocessor. In other machines, the central processing unit 91 may comprise multiple processors. A coprocessor 81 is an optional processor, distinct from the main CPU 91 that performs additional functions or assists the CPU 91.

In operation, the CPU 91 fetches, decodes, executes instructions, and transfers information to and from other resources via the computer's main data-transfer path, system bus 80. Such a system bus connects the components in the computing system 90 and defines the medium for data exchange. The system bus 80 typically includes data lines for sending data, address lines for sending addresses, and control lines for sending interrupts and for operating the system bus 80. An example of such a system bus 80 may be the PCI (Peripheral Component Interconnect) bus or PCI Express (PCIe) bus.

Memories coupled to the system bus 80 include random access memory (RAM) 82 and read only memory (ROM) 93. Such memories include circuitry that allows information to be stored and retrieved. The ROMs 93 generally contain stored data that cannot easily be modified. Data stored in the RAM 82 may be read or changed by the CPU 91 or other hardware devices. Access to the RAM 82 and/or the ROM 93 may be controlled by the controller 92. The memory controller 92 may provide an address translation function that translates virtual addresses into physical addresses as instructions are executed. The memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, the computing system 90 may comprise a peripherals controller 83 responsible for communicating instructions from the CPU 91 to peripherals, such as a printer 94, a keyboard 84, a mouse 95, and a disk drive 85. A display 86, which is controlled by a display controller 96, is used to display visual output generated by the computing system 90. Such visual output may include text, graphics, animated graphics, and video. Visual output may further comprise a GUI. The display 86 may be implemented with a CRT-based video display, an LCD-based flat-panel display, gas plasma-based flat-panel display, or a touch-panel. The display controller 96 includes electronic components required to generate a video signal that is sent to the display 86.

Further, the computing system 90 may comprise communication circuitry, such as a network adaptor 97, that may be used to connect the computing system 90 to a communications network (e.g., the network 16 of FIG. 1) to enable the computing system 90 to communicate with other components of the system and network.

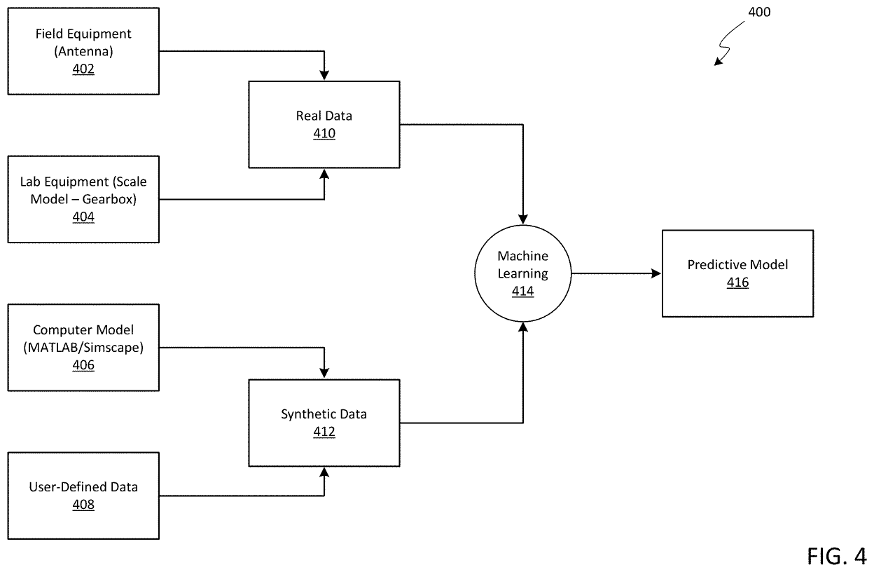

FIG. 4 is a block diagram of a process and data flow 400 that may be used in determining a predictive model 416 for performing predictive diagnostics for a device (e.g., the device 12 and/or the motor gearbox assemblies of FIGS. 1 and 2A-B). The predictive model 416 is determined via machine learning 414, which is described further herein. Inputs to the machine learning 414 may include real data 410 and synthetic data 412. The real data 410 may be derived from real-world sensors associated with deployed field equipment 402 (e.g., the actual device and/or similar devices). For example, the real-world sensors may record aspects of the field equipment's 402 operation (e.g., vibrations or acoustic emissions) and environmental conditions (e.g., ambient temperature). The real data 410 may be further derived from real-world sensors associated with lab equipment 404, such as a scale model of the device. These real-world sensors may record aspects of the lab equipment's functions, such as also vibrations or acoustic emissions. The synthetic data 412 may be derived from a computer model 406 of the device, such as a computer model implemented in MATLAB and/or Simscape software applications. The synthetic data 412 may comprise simulated sensor outputs from the computer model that are analogous to the outputs from the real-world sensors. That is, the synthetic data 412 and the real data 410 may be, at least in part, analogous to one another except that the former is based on simulated sensors and the latter is based on real sensors.

The synthetic data 412 may also be based on user-defined data 408. The user-defined data 408 may include a day and time to start capturing sensor data and/or a day and time to stop capturing sensor data. The user-defined data 408 may also include one or more scaling factors to be applied to captured sensor data (e.g., instructions to scale sensor data by n % for y period of time). The user-defined data 408 may also indicate a number of sensors associated with the device and a rate at which a sensor is to capture data (e.g., a number of measurements per second.)

The process and data flow 400 may be used in some aspects for purposes of verifying and validating the machine learning 414 algorithms. For example, a predictive model 416 may be determined based primarily on data from lab equipment 404 and associated computer model 406 data. A second predictive model 416 may be determined, via the same machine learning 414 algorithms, based primarily on analogous data from field equipment 402. The two predictive models 416 and their respective outputs may be compared for purposes of verifying and validating the machine learning 414 algorithms used to determine the two predictive models 416.

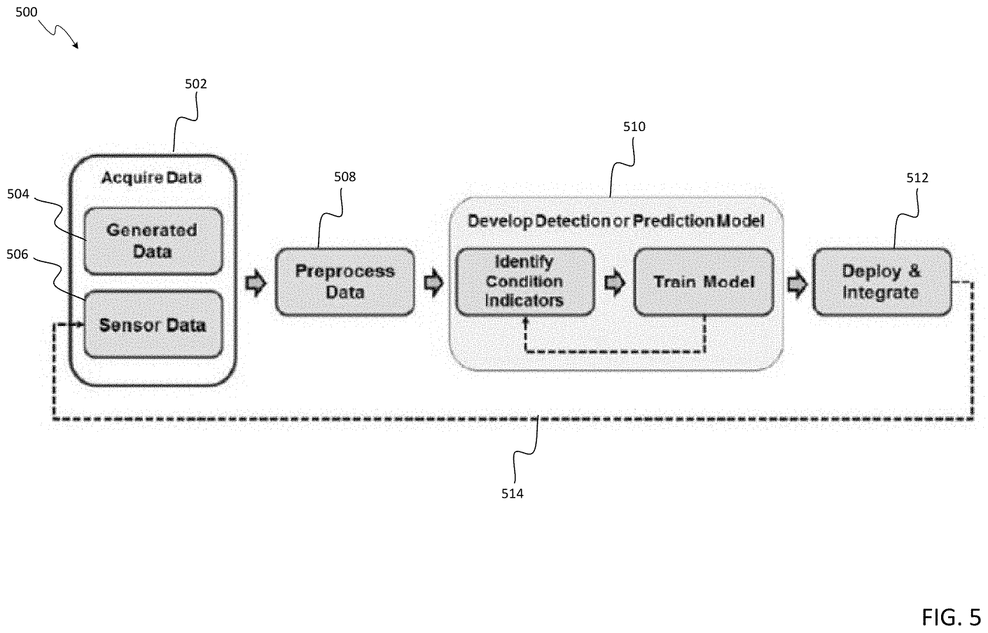

FIG. 5 is a block diagram of an example process and data flow 500 for determining a predictive model (also referred to as an analytic model) and otherwise implementing predictive diagnostics. In block 502, data comprising generated data 504 and sensor data 506 may be acquired. The generated data 504 may be determined via a computer model or simulation of a device. The generated data 504 may be the same as or similar to the synthetic data of 412 of FIG. 4. The sensor data 506 may be determined based on real-world sensors associated with the actual on-location device or a scale model of the device. The sensor data 506 may be the same as or similar to the real data 410 of FIG. 4.

In block 508, the generated data 504 and sensor data 506 may be preprocessed. The preprocessing may put the generated data 504 and sensor data 506 in a form amendable to machine learning and other analyses. For example, the preprocessing may identify features of the data sets to use as input to the machine learning. As the generated data 504 and the sensor data 506 may be in the form of a raw output of the simulated or real sensors (e.g., a voltage signal output), the generated data 504 and sensor data 506 may be converted to a data form or composite representation better indicative of the measured attribute or parameter. The data may also be normalized during preprocessing.

In block 510, a prediction and/or detection model may be developed. Condition indicators may be identified in the acquired and/or preprocessed data. For example, machine learning input features identified in block 508 may be isolated or extracted from the data. Further, condition monitoring techniques may be used on the acquired and/or preprocessed data. Here, any anomalies may be identified in a data set via machine learning (e.g., unsupervised machine learning). For example, machine learning techniques may be applied to a data set comprising a times series from a particular device, including a simulated device or scale model, and with respect to one or more measured parameters. Anomalies may be detected in a time series of vibration data for a particular antenna, for instance. This aspect of the machine learning process may comprise temporal analysis.

Additionally or alternatively, a data set may comprise a plurality of time series (e.g., a population). For example, population analysis (as opposed to the above temporal analysis) may be performed on a set of associated time series to determine any outlier time series. The set of associated time series may comprise a plurality of synthesized time series that are representative of the device (and/or similar devices) while operating within acceptable bounds (e.g., “healthy data”) and one or more real times series that are based on measured sensor data from the device (e.g., a scale model) with one or more introduced faults, such as a damaged gear.

The various data sets and respective identified anomalies may be used to train a model, such as a predictive model. For example, a predictive model may operate based on one or more measured time series from a device or similar devices that are identified as anomalous. The predictive model may be configured to identify a trend in the anomalous time series.

In block 512, the predictive model and/or any other model trained in block 510 may be deployed with respect to a particular device or a set of associated devices (e.g., co-located devices of the same type) performing mission operations in the field. Such devices may comprise one or more antennas installed at a communications station for mission operations. With respect to a predictive model or other type of determined model, “deployed” may refer to a system configuration in which the model is implemented at the device location, a remote location, or some combination of the two. Based on sensor data from an operational device, the predictive model may identify one or more anomalous time series. The predictive model may analyze the anomalous time series in conjunction with associated time series (e.g., previous anomalous time series for the device) to determine a predictive output. The predictive output may comprise a predicted time of failure, for example. As another example, the predictive output may comprise a predictive maintenance schedule or a message indicating that the device should be replaced or serviced. The predictive output may further indicate the nature of a predicted failure, such as whether it is mechanical or electrical.

Sensor data input to the predictive model in block 512, including anomalous and/or non-anomalous time series, may be used to further refine the predictive model or other model in an additional iteration of blocks 508, 510, and 512, as indicated by the dotted arrow 514. With this additional data, the predictive or other model may adjust what the model defines as an anomalous time series. For example, based on the additional data, a clustering machine learning technique may redistribute some time series in the model between a cluster associated with anomalous time series and a cluster associated with non-anomalous time series. The updated predictive or other model may be re-deployed. Further iterations of this cycle may be performed with additional sensor data to continue to refine the predictive or other model.

FIG. 6 is a block diagram of an example system 600 in which the disclosed techniques may be implemented with respect to a subject device 12. The system 600 may be generally divided into three components: a data acquisition component 610, a data management and processing component 630, and an algorithm development component 650. Implementation of the three foregoing components may generate, via machine learning, a model 660 (e.g., a predictive or analytic model) configured to determine a predicted failure, a preventative maintenance schedule, or other predictive output for the device 12 based on sensor data from sensors installed on or near the device 12. The model 660 (and/or the system 600 generally) may be further configured to iteratively refine or modify, via machine learning, the model 660 based also on sensor data associated with the device 12. Some aspects of the system 600 may be similar to those of the process and data flow 500 of FIG. 5, as well as the process and data flow 400 of FIG. 4.

The data acquisition component 610 may include in-lab data gathering and software modeling to generate a set of real and synthetic data 626 associated with a subject device 12 of the predictive analysis and modeling. The data acquisition component 610 may also include on-location data gathering to generate a set of real data 628 associated with the device 12. The data acquisition component 610 may be the same as or similar to, in at least some aspects, block 502 in FIG. 5 to acquire data. “In-lab” need not refer to a lab per se or even a single physical location, but may refer generally to controlled testing and data gathering. In contrast, “on-location” may refer generally to an uncontrolled field environment in which the device 12 (or similar devices 12) is installed.

With regard to the in-lab aspects of the data acquisition component 610, a lab computing device 612 may be used to determine and maintain a software model 620 that simulates the behavior of the device 12 (e.g., the aforementioned synthetic data). The lab computing device 612 may also direct control of a scale model 616 of the device 12, such as to determine the aforementioned real data to send to the data management and processing component 630. For example, the lab computing device 612 may control the scale model 616 via a hardware controller 614 (e.g., an Arduino microcontroller board) interfaced with the scale model 616.

The software model 620, as noted, may simulate or model the behavior of the device 12. The software model 620 may be implemented using MATLAB and Python, for example, and may be based on the known physical and mechanical aspects of the device 12. The behaviors simulated by the software model 620 are generally considered to reflect a healthy device, operating as expected, although such simulated behaviors may vary within acceptable tolerances from instance to instance of the behavior. The software model 620 may also simulate the various types of sensor data that correspond to the simulated behavior of the device 12. As such, the software model 620 may generate one or more time series of simulated sensor data. Since the simulated device is regarded as a healthy device, the simulated time series of sensor data may establish an initial nominal baseline for the associated behavior or operation of the device 12, although the nominal baseline may be subject to change over time according to, for example, the specific characteristics and uses of the device 12 and its operating environment once deployed to the field. A set of “healthy” sensor data time series, along with one or more introduced “unhealthy” sensor data times series (e.g., a time series associated with a device suffering from a fault), may be used in population analysis machine learning to enable a system to correctly identify the anomalous unhealthy time series.

The scale model 616 may comprise a physical model of the subject device 12 or sub-component thereof. The scale model 616 may operate according to control signals from the hardware controller 614. The scale model 616 is configured with one or more sensors 14 in a similar manner as the full-scale counterpart. Thus, portions of sensor data from the scale model 616 may be representative of corresponding portions of sensor data from the full-scale counterpart. For example, portions of the sensor data from the scale model 616 may be the same as or equal to the corresponding portions of the sensor data from the full-scale counterpart. Or the portions of sensor data from the scale model 616 and the portions of sensor data from the full-scale counterpart may be proportional to one another. The sensor data may form, at least in part, the real data portions of the real and synthetic data 626.

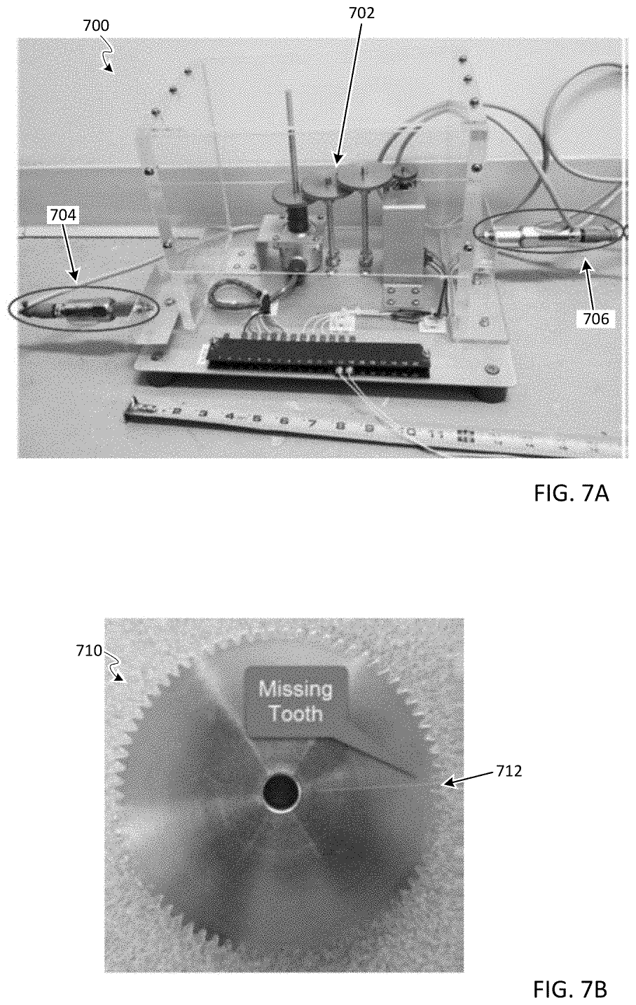

An example scale model 700 is shown in FIG. 7A. The scale model 700 is a physical model of a gearbox drive assembly, such as may be used to rotate a reflector of an aerospace antenna about one of several relevant axes. For example, a gearbox drive assembly may be part of or comprise the azimuth motor gearbox 36, the elevation motor gearbox 33, or the 3rd axis motor gearbox 32 of FIG. 2B. The scale model 700 comprises one or more gears 702, which the full-size counterpart may use to rotate the reflector of the antenna about one of the indicated axes. FIG. 7B comprises an overhead photograph of an example faulty gear 710 that is interchangeable with one or more of the gears 702 shown in FIG. 7A. This particular faulty gear 710 is missing a gear tooth and thus has an empty space 712 rather than the missing gear tooth. Such a missing tooth in the full-size counterpart may result in degraded performance of the gear, as well as degraded performance of the motor gearbox drive assembly generally. By swapping out an intact gear 702 with the faulty gear 710, nominal and off-nominal operating data (e.g., sensor data) may be determined.

The scale model 700 is configured with a first accelerometer 704 to measure horizontal vibrations and a second accelerometer 706 to measure vertical vibrations. Although not visible in FIG. 7A, the scale model 700 may be further configured with one or more thermocouples, one or more acoustic sensors, and one or more sensors to measure characteristics of an electric current (e.g., voltage, amps, and/or watts).

With continued attention to FIG. 6, a data logger 618 (e.g., a CR1000X data logger from Campbell Scientific, Inc. of Logan, Utah) may record any sensor data captured by the sensors 14 of the scale model 616. The data logger 618 may additionally or alternatively convert the raw sensor data (e.g., a voltage signal) to a form that is suitable for input to machine learning processes and prediction analysis. For example, sensor data may be converted to a particular engineering unit, or sensor data from several sensors 14 may be converted to a single composite data type. As another example, the data logger 618 may convert a sensor's 14 analog signal to a digital signal.

The data logger 618 may send the sensor data from the scale model 616 to the lab computing device 612. Additionally or alternatively, the sensor data may be sent to the data management and processing component 630. The lab computing device 612 may use the software model 620 and the sensor data to validate the scale model's 616 sensor configurations and that the scale model 616 performed as expected. That is, validate that the sensor data from the scale model 616 is meaningfully representative of the corresponding sensor data from a full-scale counterpart of the scale model 616.

With regard to the on-location aspects of the data acquisition component 610, one or more devices 12 are each configured with one or more sensors 14. A device 12 may be a field-deployed, full-scale counterpart of the scale model 616. A device 12 may be an aerospace antenna or component thereof, for example. In the particular scale model 700 example shown in FIG. 7A, a gearbox drive assembly suitable for use in an aerospace antenna is treated as a device 12 for purposes of predictive analysis. One of the device(s) 12 may be the particular subject device 12 to which predictive diagnostics is applied via the model 660. The one or more devices 12 may be similar to each other in at least some aspects, such that sensor data for one device 12 is sufficiently meaningful for determining a predictive model and other algorithms that also may be applied to another device 12 of the one or more devices 12. In some aspects and in certain stages of predictive maintenance, the on-location data gathering may be limited to a single subject device 12 of the predictive maintenance. This may be the case, for example, when an initial predictive model for a subject device 12 is refined and updated according to the new or evolving baseline behaviors of that device 12.

Sensor data from the one or more on-location devices 12 may be received by a data logger 624 to record and process the raw data from the sensors 14. The data logger 624 may be the same as or similar to the in-lab data logger 618 in terms of function. Sensor data may be sent from the data logger 624 to an on-location computing device 622. The on-location computing device 622 may also serve as a controller for the device 12. The sensor data may be sent to the data management and processing component 630 as the real data 628.

The data management and processing component 630 comprises a storage module 632, a visualization module 634, and an analysis module 636. The data management and processing component 630 may be implemented in a virtual private cloud, such as in a software as a service (SaaS) or platform as a service (PaaS) arrangement. Some aspects of the data management and processing component 630 may be the same as or similar to aspects of block 508 of FIG. 5 to preprocess data. The storage module 632, the visualization module 634, and the analysis module 636 are presented as modules for ease of description—there may or may not be such modular or functional distinctions in practice.

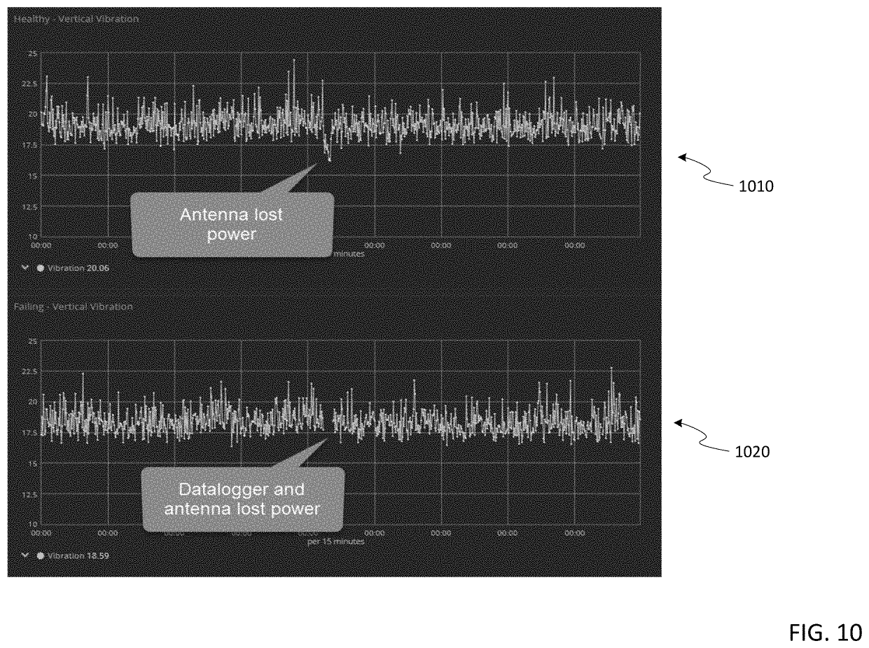

The storage module 632 may generally receive and store the real data 628 and the real and synthetic data 626 generated in the data acquisition component 610. For example, the storage module 632 may store such data in one or more databases, such as a time series database (TSDB). In continuation of any preprocessing that may have already occurred, the analysis module 636 may generally organize and format the sensor and other data for machine learning and predictive analysis. The analysis module 636 may also provide various search functions for other processes to retrieve data from the storage module 632 according to search criteria. The visualization module 634 may provide data display features. For example, the visualization module 634 may display a set of data in the form of various types of graphs or other visual representations. For example, the visualization module 634 may display sensor data in a time series line graph, as is shown in FIGS. 10-12 and 13A.

The algorithm development component 650 may generally analyze data from the data management and processing component 630 to determine the model 660. The algorithm development component 650 may be the same as or similar to block 510 of FIG. 5 to develop a detection or prediction model. Output from the algorithm development component 650 may be the same as or similar to block 512 of FIG. 5 to deploy and integrate the trained prediction or other type of model.

The algorithm development component 650 may be conceptually divided into a temporal analysis (machine learning) module 652, a condition monitoring algorithm 656, a population analysis (machine learning) module 654, and a prediction algorithm 658, although such modular distinctions are primarily for ease of description and are non-limiting. The algorithm development component 650 may involve two machine learning anomaly detection passes. The first may comprise determining any anomalous data points in a time series and roughly correspond to the temporal analysis module 652. The second may comprise determining which time series (as a whole) of a plurality of times series is anomalous and roughly correspond to the population analysis module 654.

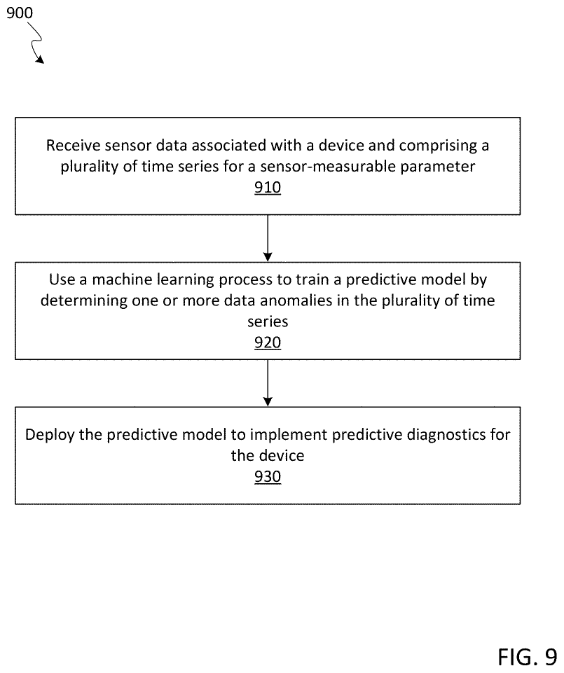

The temporal analysis module 652 may determine the condition monitoring algorithm 656 via machine learning, such as unsupervised machine learning. The condition monitoring algorithm 656 may be regarded as a model in some aspects. The condition monitoring algorithm 656 may be generally configured to determine a condition or operational aspect of the device 12. More specifically, the condition monitoring algorithm 656 may be configured to identify any data points in a time series (e.g., a time series of sensor data) that are anomalous with respect to that time series. The anomalous data points may reflect the condition of the device 12 or aspect thereof. A time series of sensor data used in the temporal analysis module 652 may be derived from the software model 620, the scale model 616, or the on-location device(s) 12. A time series that is input to the condition monitoring algorithm 656 may typically derive from sensor data from an on-location device 12. A time series may include data points for one or more parameters of the device 12, such as vibration, acoustic emission, or temperature parameters. For example, each time series shown in FIG. 9 include data points for vertical vibration, while each time series shown in FIG. 10 includes data points for both acoustic emission dB level and a composite acoustic parameter referred to as acoustic distress. The inputs to the condition monitoring algorithm 656, as well as in the temporal analysis module 652, may include environmental conditions and/or other data that is not directly related to the operation of the device 12, such as ambient temperature, humidity, wind conditions, or installation type.

A time series may correspond to sensor data associated with a particular behavior of the device 12. Sensor data that is not associated with the particular behavior may be excluded from the time series. For example a time series may include sensor data that is recorded while a motor gear assembly is activated to rotate the reflector of an example aerospace antenna, while sensor data from non-active times is excluded from the time series. In an aspect, a time series may comprise a string of one or more sub-time series, such as a string of sub-time series each corresponding to a discrete instance of the associated device behavior. For example, a time series may include both the sensor data recorded during a first activation of a motor gear assembly and the sensor data recording during a second later activation of the motor gear assembly. In other aspects, a time series may be limited to a discrete instance of the target behavior (e.g., a single activation of a motor gear assembly).

The condition monitoring algorithm 656 may be developed in the temporal analysis module 652 over the course of analyzing a plurality of associated time series. The plurality of associated time series may be from a specific device 12 or from a set of similar devices 12 (including associated deployed devices 12, simulated devices 12, and scale models of the device 12). In the former case, the resultant condition monitoring algorithm 656 may be generally configured to identify anomalous data points in a times series from the specific device 12, although it is possible that this condition monitoring algorithm 656 may be used for a device 12 that is similar to the specific device 12. In the latter case, the resultant condition monitoring algorithm 656 may be used for any device 12 of the set of similar devices 12. In addition, a condition monitoring algorithm 656 that is initially developed for a set of similar devices 12 may evolve to be associated with just a single device 12, such as after a device 12 is deployed to a field installation and the baseline operating behaviors and parameters differ from those initially assumed for the set of similar devices 12. In this manner, predictive analysis may be individualized for specific devices 12—even between devices 12 of the same type—to account for different operating conditions and demands.

The population analysis module 654 may determine the prediction algorithm 658 via machine learning, such as unsupervised machine learning. The prediction algorithm 658 may be regarded as a model in some aspects. The prediction algorithm 658 may be generally configured to determine a predictive trend (or other indicia of device failure) in a device's 12 sensor data. More particularly, the prediction algorithm 658 may be configured to determine one or more anomalous time series from a plurality of time series associated with the device 12 and determine the predictive trend or other predictive indicia based on the one or more anomalous time series. For example, determining the predictive trend may comprise determining any differences between several anomalous time series. The differential analysis may be based on the differences between anomalous data points within the respective time series rather than all of the datapoints in those time series. A plurality of time series inputs to the prediction algorithm 658 may typically come from a single deployed device 12. A plurality of time series input to the prediction algorithm 658 may relate to the same parameter or combination of parameters so that like may be compared to like in determining which time series of the plurality is or are anomalous. The inputs to the prediction algorithm 658, as well as in the population analysis module 654, may include environmental conditions and/or other data that is not directly related to the behaviors of the device 12, such as ambient temperature, humidity, wind conditions, or installation type.

The population analysis module 654 may develop the prediction algorithm 658 based on multiple pluralities of sensor data time series. For example, the population analysis module 654 may iteratively learn to identify an anomalous time series from a plurality of time series by identifying one or more anomalous time series in each of the multiple pluralities of times series. The multiple pluralities of time series may relate to the same parameter or combination of parameters, but may derive from one or more deployed devices 12, the scale model 616, the software model 620, or a combination thereof. For example, a plurality of time series analyzed by the population analysis module 654 may include a time series of simulated sensor data from the software model 620 and a time series of measured sensor data from the scale model 616. The simulated time series may represent nominal operation of the simulated device 12 while the real time series from the scale model 616 may represent off-nominal operation, such as when configured with a faulty component like the faulty gear 710 shown in FIG. 7B. By using the software model 620 to generate nominal time series, as opposed to running the equivalent real-world tests on the scale model 616 or waiting for sensor data from deployed devices 12, the population analysis may be expedited.

The model 660 (e.g., a predictive model) may be deployed to an edge computing device 662 and generally implement predictive diagnostics for a device 12, such as a field-deployed aerospace antenna or other type of device, or a set of similar devices 12. Via the edge computing device 662, the model 660 may generate a predictive output 668 associated with the device. The predictive output 668 may be additionally or alternatively generated and/or delivered to a user via the warning system 20 of FIG. 1.

The model 660 may be determined based on the algorithm development component 650 and, more particularly, the condition monitoring algorithm 656 and the prediction algorithm 658. The model 660 may instantiate at least some aspects of the condition monitoring algorithm 656 and the prediction algorithm 658 with respect to a device 12. For example, the model 660 may be configured to receive a time series of sensor data from the sensors associated with a device 12. The model 660 may determine one or more anomalous data points in the time series. Additionally or alternatively, the model 660 may receive a plurality of sensor data time series associated with the device 12. The model 660 may determine one or more anomalous time series from the plurality of time series. The one or more anomalous time series may be determined based on the anomalous data points identified in the plurality of respective time series by the conditioning monitoring aspects of the model 660.

The model 660 may determine a predictive trend or other predictive indicia in the one or more anomalous time series and data points thereof. The predictive trend may comprise a trend towards failure of the device 12. Determining the predictive trend may comprise comparing anomalous time series and determining any differences between those anomalous time series. The foregoing may be performed with respect to a single measured parameter associated with a device 12 (e.g., horizontal vibration, vertical vibration, temperature, acoustic emissions, acoustic dB level, acoustic frequency, voltage, amperage, wattage, etc.) or a combination of such parameters. For example, a sensor data time series may comprise data points for several parameters (e.g., both horizontal and vertical vibrations).

As noted above, the model 660 may generate a predictive output 668 based on sensor data received from a device 12. The predictive output 668 may comprise a predicted time of failure, a preventative maintenance schedule for the device, or a message for the device to be serviced or replaced. The predictive output 668 may be provided to a user, such as a maintenance technician. The user may preferably service the device before any failure.

The model 660 may be configured to implement predictive diagnostics for a specific device 12. Or the model 660 may be configured to implement predictive diagnostics for any device 12 of a plurality of similar devices 12. In some aspects, the model 660 may be initially configured for any device 12 of a plurality of similar devices 12, but may be later updated to perform predictive diagnostics for only a specific device 12 based on subsequent sensor data from that device 12. For example, the criteria for what would be considered an anomalous data point in a time series from that device 12 and/or the criteria for what would be considered an anomalous time series in a plurality of time series from that device 12 may be iteratively updated once the device 12 is deployed to the field. In other words, a device's 12 nominal baseline with respect to its sensor data may be adjusted according to the device's 12 actual in-field operation and/or environmental conditions. The baseline may be again adjusted if the environmental conditions or the device's 12 operations further change.

The iterative adjustments to a model 660 associated with a specific device 12 is illustrated in FIG. 6. In an example, the model 660 associated with the specific device 12 is initially determined. The initial model 660 may be unique to this specific device 12 or may be generalized for initial use with any devices of the specific device's 12 type (e.g., make and model). In the former case, the model 660 may have been determined based on initial real data 628 (e.g., sensor data) from the device 12, such as during onsite testing before the device 12 became fully ready for mission operations. In the latter case, for example, the model 660 may have been determined based on a scale model 616 and/or software model 620 of the device 12.

The model 660 may be deployed to an edge computing device 662 associated with the specific device 12. The edge computing device 662 may be in communication with the device 12 via the on-location computing device 622 at the device's 12 location. In some embodiments, the edge computing device 662 and the on-location computing device 622 may be the same computing device. The specific device 12 may enter full operations and report real data 664 back to the edge computing device 662. The real data 664 may be sent to the edge computing device 662 periodically and/or in real-time. The real data 664 may be used by the current version of the model 660 for purposes of monitoring the device 12 for any predicted failures and generating a predictive output 668, as described above. More relevant to this example, the real data 664 may be used to update the model 660.

For example, the real data 664 may be reported to the edge computing device 662 following maintenance of the device 12 or at the time that the device 12 is installed at the location. A technician may initiate test operations of the device 12 at this time to capture a body of real data 664 that may be used to update (or initialize) the model 660. For example, the technician may cause an example aerospace antenna to rotate its reflector in one-degree increments. The real data 664 captured during each rotational increment may be reported to the edge computing device 662. Additionally or alternatively, the real data 664 may be reported to the edge computing device 662 according to the normal operation of the device 12. In this instance, the real data 664 may be reported to the edge computing device 662 in real-time or at pre-determined intervals.

As indicated by the dotted line 666, the edge computing device 662 may relay the real data 664 from the specific device 12 to the data management and processing component 630. The real data 664 may be sent to the data management and processing component 630 via the same communication channels as the initial real data 628. In an aspect, the real data 664 may be regarded as a certain instance of the real data 628, but is represented separately for purposes of this example use case. At the data management and processing component 630, the new real data 664 may be merged with existing data (e.g., sensor data) associated with the device, if any. The merged data may be passed to the algorithm development component 650. There, it may undergo temporal analysis and population analysis to determine an updated condition monitoring algorithm 656 and/or an updated prediction algorithm 658, respectively. In turn, the updated condition monitoring algorithm 656 and the updated prediction algorithm 658 may be implemented in an updated version of the model 660. The updated version of the model 660 may embody a new nominal baseline for the device's 12 behavior and resultant sensor data.

The updated version of the model 660 may be deployed to the edge computing device 662. The updated version of the model 660 may then be applied to subsequent real data 664 from the example specific device 12 to determine any predictive outputs 668. The subsequent real data 664 may be additionally or alternatively used in an additional iteration of the above-described process to update the model 660. This cyclic process may be continued for as long as desired so that the model 660 reflects the current nominal baselines for the device 12, which may shift over time due to changes in operational demands and/or environmental conditions.

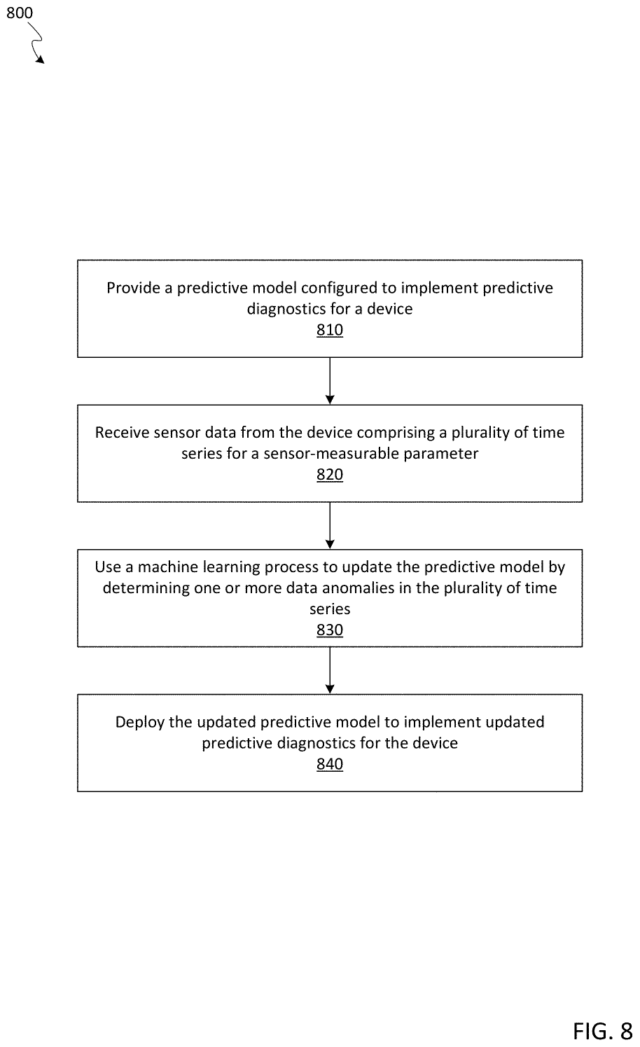

FIG. 8 illustrates a method 800 for updating a predictive model (also referred to as an analytic model) configured to implement predictive diagnostics for a device (e.g., the device 12 of FIGS. 1, 2A-B, and 6). The device may comprise an aerospace antenna or component thereof. At step 810, the initial predictive model is provided. The initial predictive model may be configured generically for use with other devices of the same type and not yet customized for the particular operational demands and environmental conditions of the instant device. The predictive model may be configured to determine a predictive output, such as a predicted time of failure, a preventative maintenance schedule, or a message to service or replace the device. The predictive output may be determined by the predictive model based on sensor data from the device, which may comprise one or more senor data time series for a sensor-measurable parameter associated with operation of the device.

At step 820, sensor data is received from the device that comprises a plurality of sensor data time series for the sensor-measurable parameter. The sensor-measurable parameter may comprise vibration, horizontal vibration, vertical vibration, temperature, acoustic emission, acoustic dB level, acceleration, acoustic frequency, voltage, amperage, or wattage.

At step 830, one or more machine learning processes may be used to update the predictive model based on the received sensor data, such as determining one or more data anomalies in the plurality of sensor data time series. For example, in the temporal analysis (ML) module 652 of FIG. 6, one or more anomalous data points in each of one or more sensor data time series of the plurality of sensor data time series may be determined. Additionally or alternatively, in the population analysis (ML) module 654 of FIG. 6, one or more anomalous sensor data time series from the plurality of sensor data time series may be determined. Further, updating the predictive model may comprise comparing two or more of the determined anomalous sensor time series to determine a predictive trend.

At step 840, the updated predictive model is deployed to implement updated predictive diagnostics for the device. The predictive model may be updated when the device is initially installed for mission operation or following maintenance, for example. In either case, a technician may cause the device to undergo certain test operations to establish a body of sensor data with which the initial predictive model may be updated. The method 800 may be repeated as needed to further update the predictive model for the device. This may be done at regular intervals or following particular milestones, such as maintenance. Or the predictive model may be updated on a rolling basis according to a continuous input of sensor data from the device to the system.

FIG. 9 illustrates a method 900 for training a predictive model (also referred to as an analytic model) that will be configured to implement predictive diagnostics for a device (e.g., the device 12 of FIGS. 1, 2A-B, and 6). The device may comprise an aerospace antenna or component thereof.

At step 910, sensor data associated with a device is received. The sensor data may comprise a plurality of sensor data time series for a sensor-measurable parameter associated with operation of the device. The sensor data may be derived from at least one of a computer simulation or model of the device, a scale model of the device, or a field-deployed device that is similar to the instant device (e.g., of the same type). The sensor-measurable parameter may comprise vibration, horizontal vibration, vertical vibration, temperature, acoustic emission, acoustic dB level, acceleration, acoustic frequency, voltage, amperage, or wattage.

At step 920, one or more machine learning processes are used to train the predictive model associated with the device. The one or more machine learning processes may comprise determining one or more data anomalies in the plurality of sensor data time series. For example, in the temporal analysis (ML) module 652 of FIG. 6, one or more anomalous data points in each of one or more sensor data time series of the plurality of sensor data time series may be determined. Additionally or alternatively, in the population analysis (ML) module 654 of FIG. 6, one or more anomalous sensor data time series from the plurality of sensor data time series may be determined. Further, training the predictive model may comprise comparing two or more of the determined anomalous sensor time series to determine a predictive trend.

At step 930, the predictive model is deployed to implement predictive diagnostics for the device. The predictive model may be configured to determine a predictive output based on sensor data from the device, such as one or more sensor data time series for the sensor-measurable parameter. The predictive output may comprise a predicted time of failure, a preventative maintenance schedule, or a message to replace or service the device.

FIG. 10 illustrates a pair of example time series line graphs. A first, topmost line graph 1010 plots the vertical vibrations associated with a healthy electromechanical device, such as a motor gearbox of an aerospace antenna. A second, lowermost line graph 1020 also plots vertical vibrations, but from a failing similar electrotechnical device. The datapoints in the line graphs 1010, 1020 represent vibration frequency, albeit in normalized engineering units. The time series shown in the line graphs 1010, 1020 are example of sensor data time series, as referred to throughout the application.

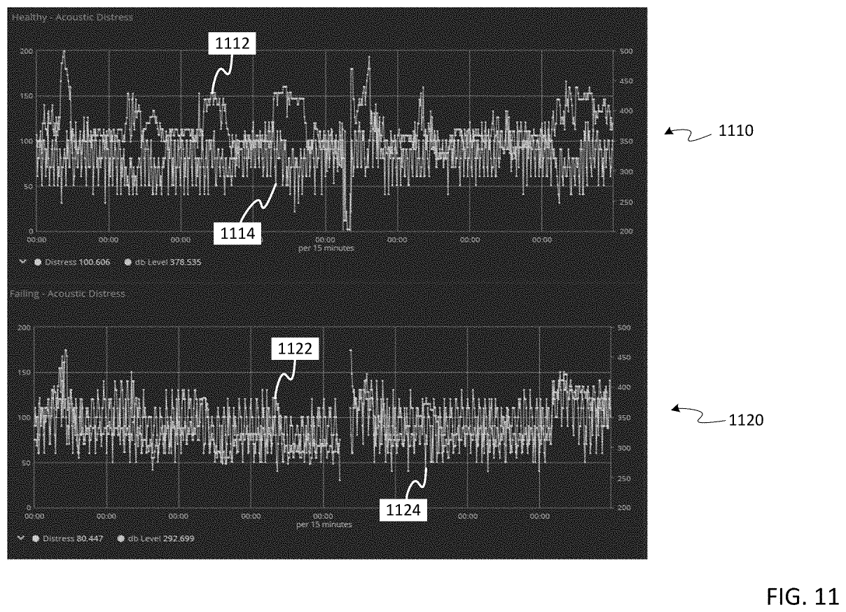

FIG. 11 illustrates a pair of example time series line graphs directed towards acoustic data. A first, topmost line graph 1110 plots both a dB level time series 1112 and an “acoustic distress” time series 1114 associated with a healthy electromechanical device. Acoustic distress may refer to a composite acoustic parameter. A second, lowermost line graph 1120 also plots both a dB level time series 1122 and an acoustic distress time series 1124, but for a failing electromechanical device.

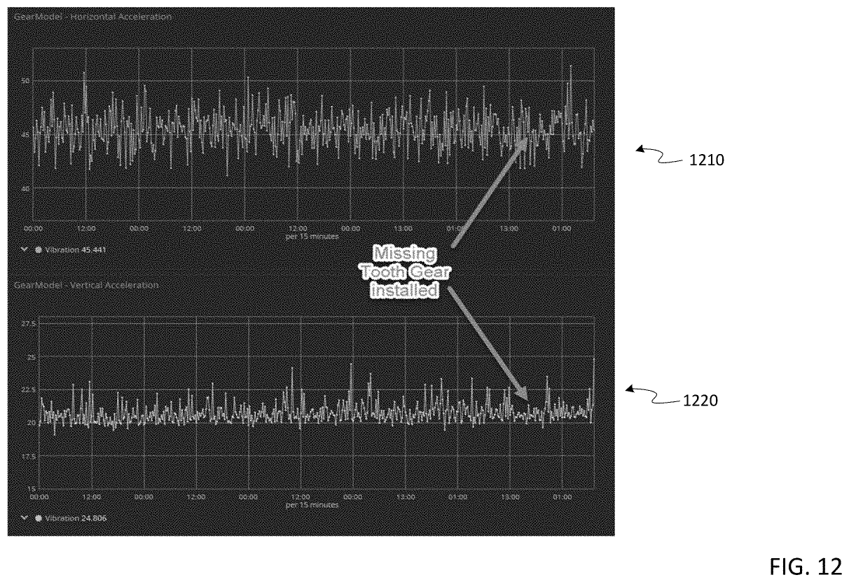

FIG. 12 illustrates a pair of example time series line graphs showing vertical acceleration data from a scale model (e.g., the scale model 616 of FIG. 6 or the scale model 700 of FIG. 7A) in which a gear having a missing tooth (e.g., the faulty gear 710 of FIG. 7B) is installed in the scale model towards the end of the time series. A first, topmost line graph 1210 plots a time series for horizontal acceleration and a second, lowermost line graph 1220 plots a time series for vertical acceleration. The point in the time series at which the gear with the missing tooth was installed is marked in the diagram. It is noted that there is no readily observable difference in the time series before the faulty gear was installed and after the faulty gear was installed. Yet the techniques described herein have been shown to detect these seemingly imperceptible shifts in the time series.

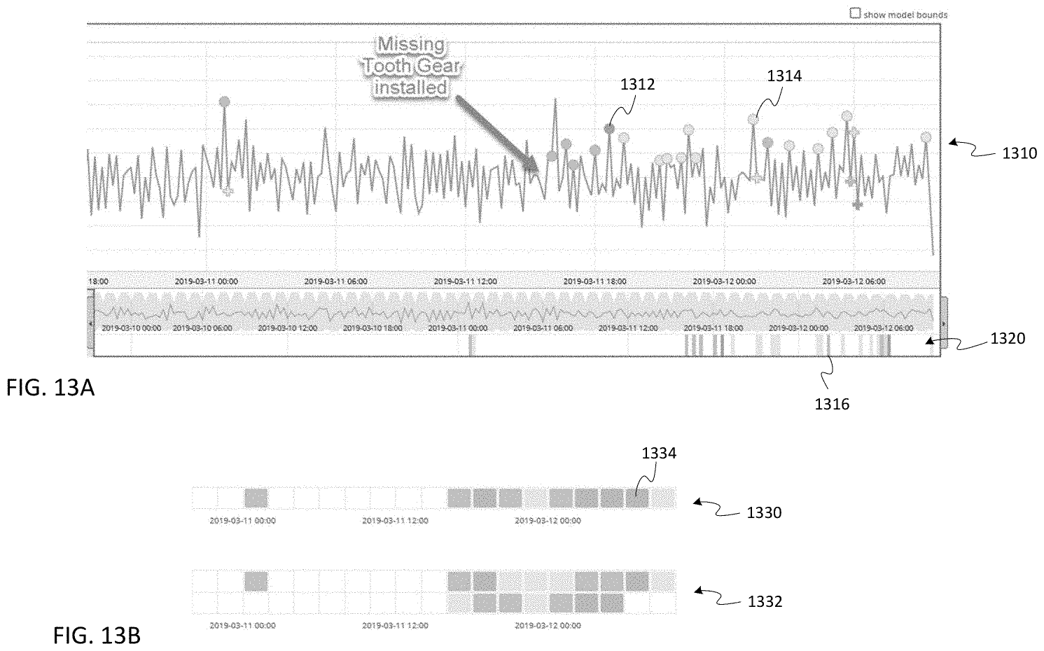

FIG. 13A illustrates a time series line graph 1310 and a time series timeline 1320. These graphs further visualize at least some of the same sensor data shown in FIG. 12. Anomalous data points in the time series line graph 1310 are indicated by circles, such as the circles 1312 and 1314. Anomalous data points in the time series timeline 1320 are indicated by vertical bars, such as the vertical bar 1316. FIG. 13B illustrates time series block graphs 1330, 1332 that visualize at least some of the same data shown in FIG. 13A. The highlighted blocks, such as the block 1334, may represent anomalous data points.

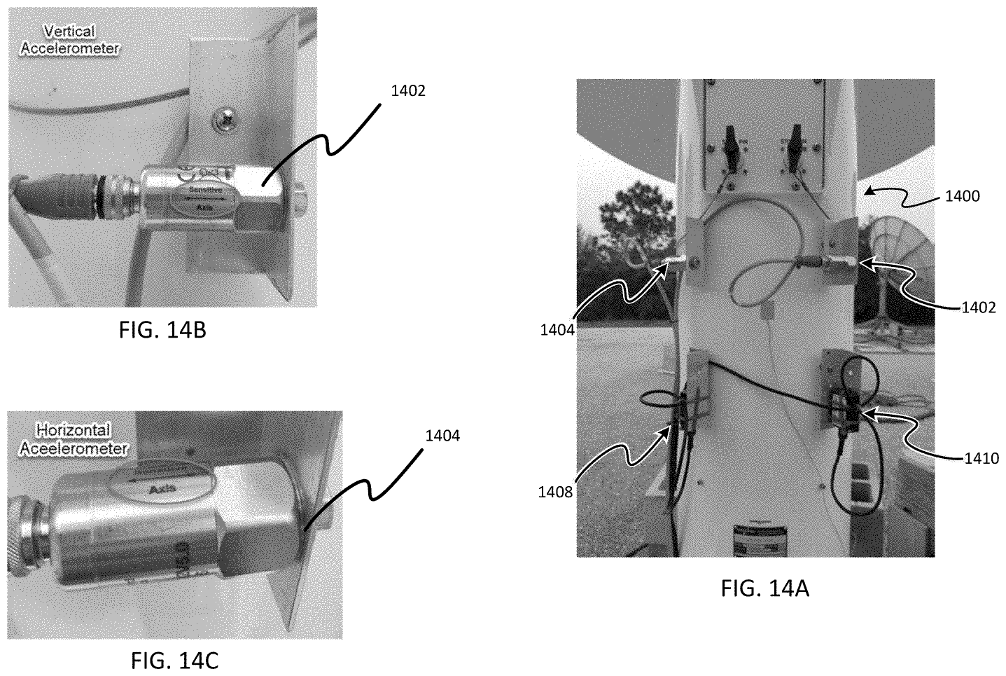

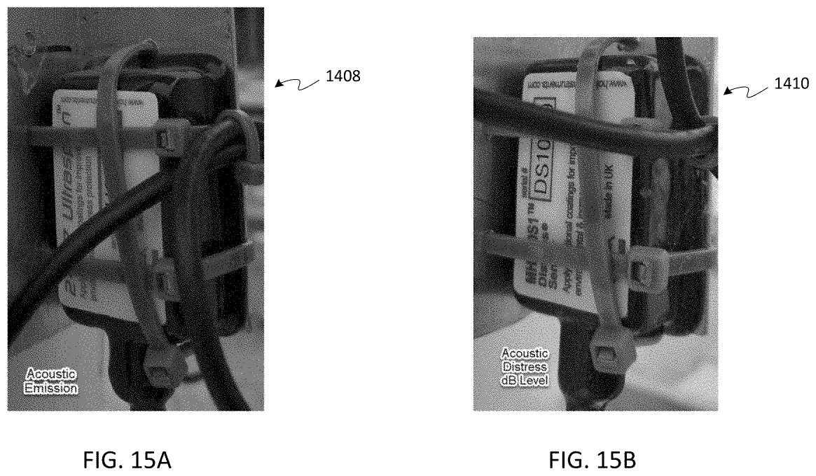

FIG. 14A illustrates (in the foreground) a partial view of a pedestal assembly 1400 of an aerospace antenna. The pedestal assembly 1400 is configured with a vertical accelerometer 1402 and a horizontal accelerometer 1404. The vertical accelerometer 1402 and the horizontal accelerometer 1404 may measure vertical and horizontal accelerations, respectively and/or vertical and horizontal vibrations, respectively. FIG. 14B shows a close-up view of the vertical accelerometer 1402 and FIG. 14C shows a close-up view of the horizontal accelerometer 1404. The pedestal assembly 1400 is further configured with an acoustic emission sensor 1408 and an acoustic distress/dB level sensor 1410. The acoustic emission sensor 1408 is also shown in FIG. 15A and the acoustic distress/dB level sensor 1410 is also shown in FIG. 15B.

While the system and method have been described in terms of what are presently considered specific embodiments, the disclosure need not be limited to the disclosed embodiments. It is intended to cover various modifications and similar arrangements included within the spirit and scope of the claims, the scope of which should be accorded the broadest interpretation to encompass all such modifications and similar structures. The present disclosure includes any and all embodiments of the following claims.

What is claimed is:

1. A method comprising:
providing an analytic model configured to implement predictive diagnostics for an electromechanical device, wherein the analytic model is configured to determine a predictive output based on first sensor data from the electromechanical device;
receiving second sensor data from the electromechanical device comprising a plurality of time series for a sensor-measurable parameter associated with operation of the electromechanical device;
using one or more machine learning processes to update the analytic model, wherein the one or more machine learning processes comprise determining one or more data anomalies in the plurality of time series for the sensor-measurable parameter; and
deploying the updated analytic model to implement updated predictive diagnostics for the electromechanical device, wherein the updated analytic model is configured to determine a predictive output based on third sensor data from the electromechanical device.

2. The method of claim 1, wherein the electromechanical device comprises at least one of an aerospace antenna or a component of an aerospace antenna.

3. The method of claim 1, wherein the one or more machine learning processes comprise determining one or more anomalous data points for the sensor-measurable parameter in each of one or more time series of the plurality of times series.

4. The method of claim 3, wherein the one or more machine learning processes further comprise determining one or more anomalous time series of the plurality of times series.

5. The method of claim 4, wherein the updating the analytic model comprises comparing two or more of the determined anomalous time series to determine a predictive trend for the electromechanical device.

6. The method of claim 1, wherein the predictive output comprises at least one of a predicted time of failure for the electromechanical device, a preventative maintenance schedule for the electromechanical device, or a message to service or replace the electromechanical device.

7. The method of claim 1, wherein the sensor-measurable parameter comprises one or more of vibration, horizontal vibration, vertical vibration, temperature, acoustic emission, acoustic dB level, acceleration, acoustic frequency, voltage, amperage, or wattage.

8. The method of claim 1, wherein the using one or more machine learning processes to update the analytic model is responsive to at least one of installing the electromechanical device on-site for mission operations or performing maintenance on the electromechanical device.

9. A method comprising:
receiving sensor data associated with an electromechanical device and comprising a plurality of time series for a sensor-measurable parameter associated with operation of the electromechanical device, wherein the sensor data is determined via at least one of a computer simulation of the electromechanical device, a scale model of the electromechanical device, and a field-deployed electromechanical device of the same type as the electromechanical device;
using one or more machine learning processes to train an analytic model associated with the electromechanical device, wherein the one or more machine learning processes comprise determining one or more data anomalies in the plurality of time series for the sensor-measurable parameter; and
deploying the analytic model to implement predictive diagnostics for the electromechanical device, wherein the analytic model is configured to determine a predictive output based on sensor data from the electromechanical device.

10. The method of claim 9, wherein the electromechanical device comprises at least one of an aerospace antenna or a component of an aerospace antenna.

11. The method of claim 9, wherein the one or more machine learning processes comprise determining one or more anomalous data points for the sensor-measurable parameter in each of one or more time series of the plurality of times series.

12. The method of claim 11, wherein the one or more machine learning processes further comprise determining one or more anomalous time series of the plurality of times series.

13. The method of claim 12, wherein the updating the analytic model comprises comparing two or more of the determined anomalous time series to determine a predictive trend for the electromechanical device.

14. The method of claim 9, wherein the predictive output comprises at least one of a predicted time of failure for the electromechanical device, a preventative maintenance schedule for the electromechanical device, or a message to service or replace the electromechanical device.

15. The method of claim 9, wherein the sensor-measurable parameter comprises one or more of vibration, horizontal vibration, vertical vibration, temperature, acoustic emission, acoustic dB level, acceleration, acoustic frequency, voltage, amperage, or wattage.

16. A system comprising:
an electromechanical device associated with one or more sensors configured to measure respective one or more parameters associated with operation of the electromechanical device; and
a computing system configured to communicate with the electromechanical device, wherein the computing system is further configured to:
deploy an analytic model configured to implement predictive diagnostics for the electromechanical device;
receive sensor data from the electromechanical device comprising a plurality of time series for a parameter of the one or more parameters;
use one or more machine learning processes to update the analytic model, wherein the one or more machine learning processes comprise determining one or more data anomalies in the plurality of time series for the parameter; and
deploy the updated analytic model to implement updated predictive diagnostics for the electromechanical device, wherein the updated analytic model is configured to determine a predictive output based on sensor data from the electromechanical device.

17. The system of claim 16, wherein the one or more machine learning processes comprise determining one or more anomalous data points for the parameter in each of one or more time series of the plurality of times series.

18. The system of claim 17, wherein the one or more machine learning processes further comprise determining one or more anomalous time series of the plurality of times series.

19. The system of claim 18, wherein the updating the analytic model comprises comparing two or more of the determined anomalous time series to determine a predictive trend for the electromechanical device.

20. The system of claim 16, wherein the predictive output comprises at least one of a predicted time of failure for the electromechanical device, a preventative maintenance schedule for the electromechanical device, or a message to service or replace the electromechanical device.
